(19) United States
(12) Patent Application Publication
(10) Pub. No.: US 2009/0323818 A1
(43) Pub. Date: Dec. 31, 2009

(54) ASYNCHRONOUS MEDIA FOUNDATION TRANSFORM

(75) Inventors: Rebecca C. Weiss, Vienna, VA (US); Alexandre V. Grigorovitch, Redmond, WA (US); Glenn F. Evans, Kirkland, WA (US); Robin C.B. Speed, Winchester (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/163,444

(22) Filed: Jun. 27, 2008

(51) Int. Cl. H04N 11/02

(52) U.S. Cl. 375/240.18; 375/E07.211

(57) ABSTRACT

This disclosure describes methods, systems, and programming interfaces for more efficiently processing media data in a media pipeline. In one embodiment, media flow in a media system is coordinated using a media foundation transform supported by a programming interface. The programming interface generates input and output events to the requisite media system thereby permitting the media foundation transform control over when input frames are requested and received and output frames are retrieved.

### BACKGROUND

Consumers live in an era surrounded by digital media. Today's consumers can view high-definition digital television and millions of people download digital music every day. Utilizing a digital media platform, today's digital content is often viewed or listened to on a personal computer or a pocket PC. To fully embrace the digital media content while operating in such a forum, the digital media platform should offer unparalleled audio and video quality.

Most digital media platforms, such as Windows(g Media player, use DirectShow®, DirectX® Media Objects, Media Foundation Transforms, or some variation thereof, to manage digital media content. However, these digital media platforms do not offer unparalleled audio and video quality.

DirectShow® is an architecture for streaming media on the Microsoft Windows® platform. DirectShow® uses a modular architecture, where each stage of processing is done by a Component Object Model (COM) object called a filter. DirectShow® filters which are by nature are asynchronous, which allows them to have control over obtaining input frames and pushing out output frames. However, DirectShow® filters are intended to be used as part of an entire DirectShow® graph and, therefore, the filters are not a solution should one desire to use the filter in isolation.

DirectX® Media Objects (DMOs) are Com-based data-streaming components. In some respects, DMOs are similar to DirectShow® filters. For example, like DirectShow® filters, DMOs take input data and use it to produce output data. However, unlike DirectShow® filters, DMOs contain synchronous interfaces. Synchronous interfaces require the client to fill the input data and the DMO to write new data into output data. Further, unlike DirectShow® filters, DMOs can be used as stand-alone media processing components.

Media Foundation Transforms (MFTs) operate similarly to that of the DMOs. MFTs primarily are used to implement decoders, encoders, mixers, and digital signal processors. Like DMOs, MFTs contain synchronous interfaces that can be used as stand-alone media processing components. Also similar to DMOs, the client fills the input data and the MFT writes new data into the output data.

However, neither DirectShow®, DirectX® Media Objects, nor Media Foundation Transforms provide a processing component that includes an asynchronous interface as well as the capability of being used as a stand-alone media processing component. Therefore, as multimedia systems and architectures evolve, there is a continuing need for systems and architectures that are flexible in terms of implementation and the various environments in which such systems and architectures can be employed.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In view of the above, this disclosure describes various exemplary systems, computer program products, and application programming interfaces for generating or transforming media data to create asynchronous media foundation transforms. The disclosure describes implementing at least one interface to coordinate a flow of one or more media frames and receiving the one or more media frames at a pipeline object. Furthermore, the disclosure describes how the one or more interfaces make an input call and an output call.

The asynchronous media foundation transforms fill a need to use a simple media processing component as a stand-alone component or as part of a media pipeline. Furthermore, there is improved efficiency with independent obtaining of input frames and retrieval of output frames. Thus, control of inputs and outputs is improved and a user experience is enhanced.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 illustrates a block diagram for an exemplary computing environment for asynchronous media transform.

FIG. 2 illustrates a block diagram of an exemplary media system.

FIG. 3 illustrates a flow chart within a media pipeline of the media system according to FIG. 2.

FIG. 4 illustrates a block diagram for an asynchronous media foundation transform of the media pipeline according to FIG. 3.

FIG. 5 illustrates a block diagram for an exemplary asynchronous media foundation transform.

FIG. 6 illustrates a process flow for obtaining and feeding input frames for an asynchronous media foundation transform according to FIG. 4

FIG. 7 illustrates atypical exemplary process flow for retrieving output frames from an asynchronous media foundation transform according to FIG. 4.

FIG. 8 illustrates a block diagram for an exemplary computing environment.

### DETAILED DESCRIPTION

This disclosure describes various exemplary systems, computer program products, and application programming interfaces for generating media data from a source object to create asynchronous media foundation transforms. The disclosure describes implementing at least one interface to coordinate a flow of one or more media frames and receiving the one or more media frames at a pipeline object. Furthermore, the disclosure describes how the one or more interfaces make an input call and an output call.

This disclosure is also directed to a process of media processing within a media system. More specifically, this disclosure is directed to media processing within a media foundation pipeline.

The asynchronous media foundation transforms described herein are not limited to any particular application, but may be applied to many contexts and environments. In one implementation, the asynchronous media foundation transforms may be employed in media systems including, without limitation, Windows Media Player®, Quicktime®, RealPlayer®, and the like. In another implementation, the asynchronous media foundation transform may be employed in an environment which does not include a computing environment.

### Exemplary Media System

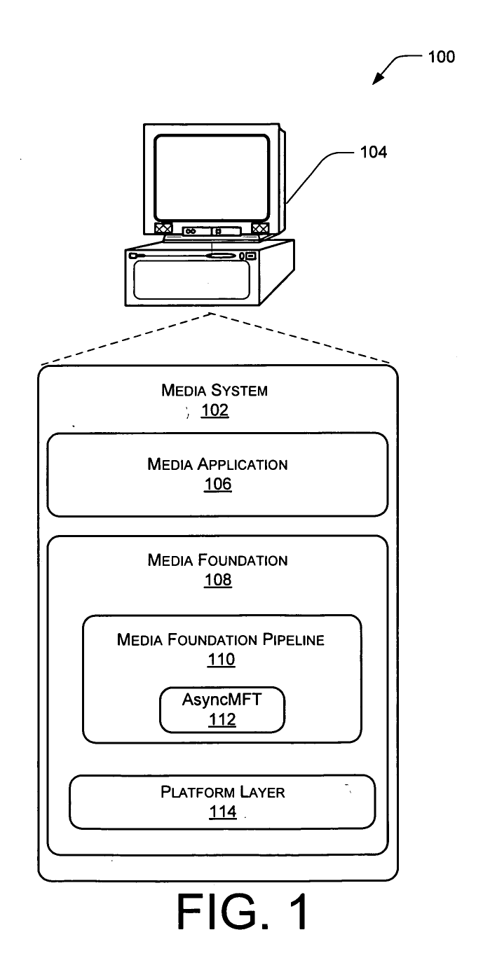

FIG. 1 illustrates a block diagram of an exemplary environment 100 for a media system 102 in accordance with one embodiment. Media system 102 can be implemented, at least in part, by one or more suitable computing devices, such as computing device(s) 104. It should be noted that while media system 102 is described in the context of media data processing in a computing environment, it is to be appreciated and understood that it can be employed in other contexts and environments involving other types of data processing without departing from the spirit and scope of the claimed subject matter.

Media system 102 includes a media application 106, such as Windows Media Player®, Quicktime® or RealPlayer® for example. Media application 106 provides a user interface (UI) with various user controls such as command buttons, selection windows, dialog boxes and the like to facilitate interaction with, and presentation to a user of the media system 102. Media application 106 coordinates and otherwise manages one or more sources of media data, such as incoming media data (downloaded) and/or items in a local media library, or items in a playlist specifying a plurality of media data items associated with the media system 102, as will be appreciated and understood by one skilled in the art. The media data can include, without limitation, media data content and/or metadata associated with the data. Media data is any information that conveys audio and/or video information, such as audio resources (e.g., music, spoken word subject matter, etc.), still picture resources (e.g., digital photographs, etc.), moving picture resources (e.g., audio-visual television media programs, movies, etc.), and the like. Furthermore, examples of media data may include substantially real-time content, non-real time content, or a combination of the two. Sources of substantially real-time content generally includes those sources for which content is changing over time, such as, for example, live television or radio, webcasts, or other transient content. Non-real time content sources generally include fixed media readily accessible by a consumer, such as, for example, pre-recorded video, audio, text, multimedia, games, media captured by a device such as a camera, or other fixed media readily accessible by a consumer. In addition, the media data may be compressed and/or uncompressed. The media system 102 also includes, without limitation, a media foundation 108, a media foundation pipeline 110, an asynchronous media foundation transformer 112, and a platform layer 114.

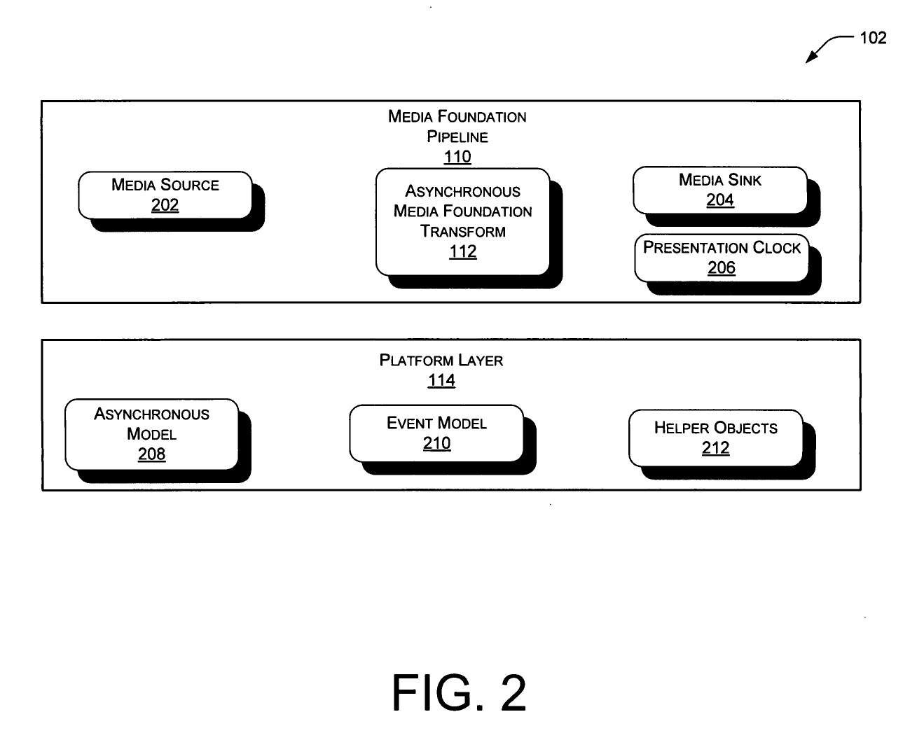

FIG. 2 illustrates a block diagram of an exemplary media system 102. The media foundation pipeline 110 holds the objects that create, manipulate, and consume the media data. Typically, as will be appreciated and understood by one skilled in the art, the media foundation pipeline 110 components are located at a level in the computing environment that is lower than the level of media application 106. The media foundation pipeline 110 is made up of a media source 202, the asynchronous media foundation transform 112, a media sink 204, and a presentation clock 206. However, it is to be appreciated that the media foundation pipeline 110 may be made up of other components.

Media source 202 includes an object that can be used to read a particular type of media content from a particular source. For example, one type of media source might read compressed video data and another media source might read compressed audio data. The data can be received from a data store or from a device capturing “live” multimedia data (e.g., a camcorder). Alternately or additionally, a media source might separate the data stream into compressed video and compressed audio component. Alternatively or additionally, a media source 202 might be used to receive compressed data from over the network. A media source can encapsulate various data sources, like a file, or a network.

Asynchronous Media Foundation Transform (AsynchMFT) 112 converts or otherwise processes the media data from media source 202. Media sink 204 is the destination for the media data within the media pipeline 110. Media sink 204 is typically associated with a particular type of media content and presentation. Thus, audio content might have an associated audio sink for playback such as an audio renderer. Likewise, video content might have an associated video sink for playback such as a video renderer. Additional media sinks can archive multimedia data to computer-readable media, e.g. a disk file, a CD, or the like. Additionally, media sinks can send data over the network. The rate at which the media sink 204 consumes the media data is controlled by the presentation clock 206. The media sink supplies the output of the topology path to one or more presentation devices for presentation to a user. In one implementation, there is one topology path supplying output for presentation. In another implementation, there may be more than one topology paths supplying output for presentation.

Platform layer 114 is comprised of helper objects that are used by the other layers of the system 102 to process media data. In addition to various helper objects, the platform layer 114 is shown to include, without limitation, an asynchronous model 208, an event model 210, and a helper object 212.

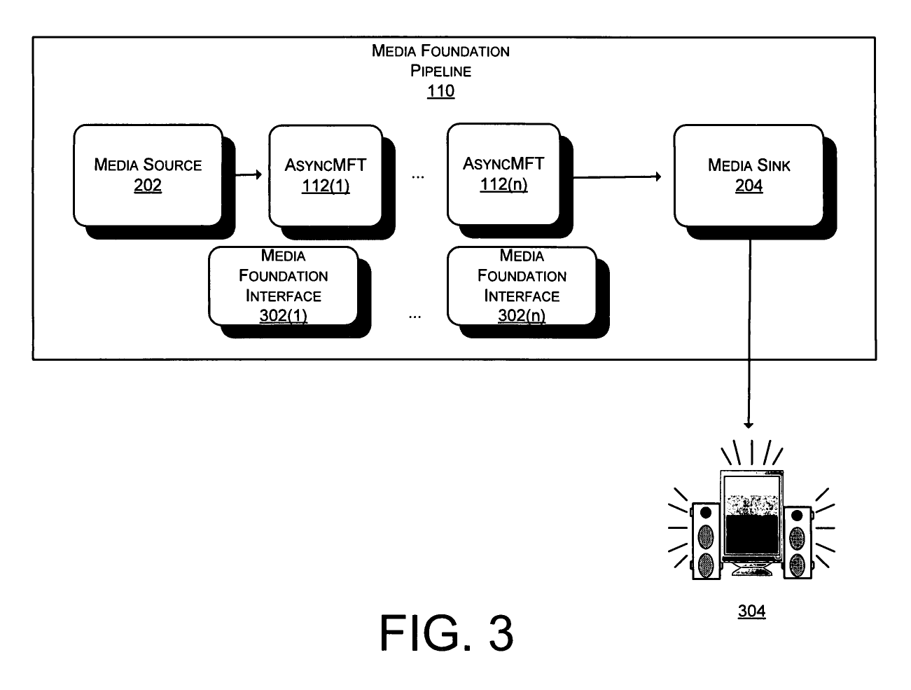

FIG. 3 is a block diagram of an exemplary media foundation pipeline 110. As illustrated in FIG. 3, the media source 202, the one or more AsyncMFTs 112(1)-112(n), and the media sink 204 do not transport media data through the media foundation pipeline 110 by themselves. Instead, the objects should be hosted by a software component, such as one or more media foundation interfaces 302(1) . . . 302(n), which requests data from the sources and moves the data through the one or more AsyncMFTs 112(1)-112(n) to the media sinks for a presentation 304 to the user.

One or more presentation devices can be any suitable output device(s) for presenting the media data to a user, such as a monitor, speakers, or the like. In simple scenarios, a presentation may include only a single media sink (e.g., for a simple audio-only playback presentation the media sink may be an audio renderer). However, a presentation may include more than one media sink, for example, to play audio/video streams received from a camcorder device. In addition, there may be one or more paths within the media pipeline 210. In one implementation, one path may be used to transport audio data, while a second path may be used to transport video data. In other implementations, one path may transport both audio and video data. In yet another implementation a video path and an audio path may diverge and/or merge.

### The Asynchronous MFT

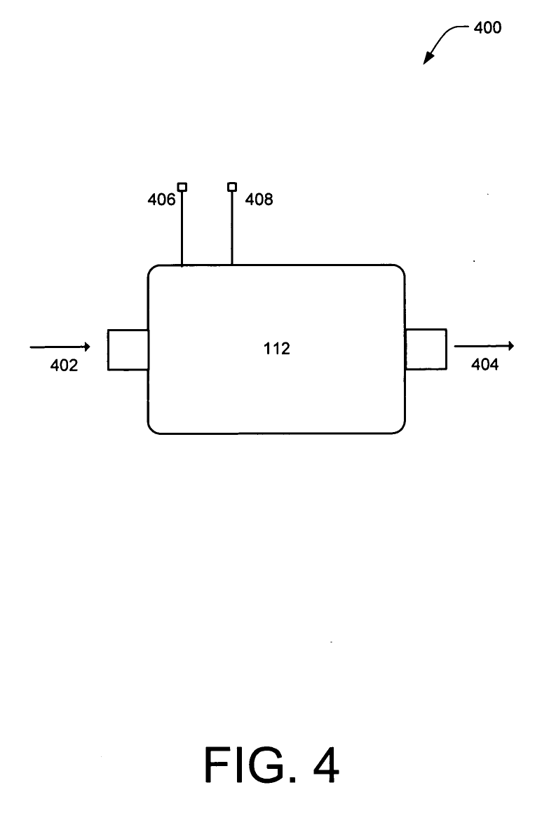

FIG.4 illustrates a block diagram of an asynchronous media foundation transform 400 found in the media foundation pipeline 110. The Asynchronous MFT (AsyncMFT) model allows the AsyncMFT 112 to control the timing according to which AsyncMFT receives input frames 402 and produces output frames 404. As shown in FIG. 4 the AsyncMFT 112 supports a first IMFTransform interface 406 and a second programming interface, an IMFMediaEventGenerator interface 408. The IMFMediaEventGenerator interface can be used to retrieve events from any media foundation object that generates events.

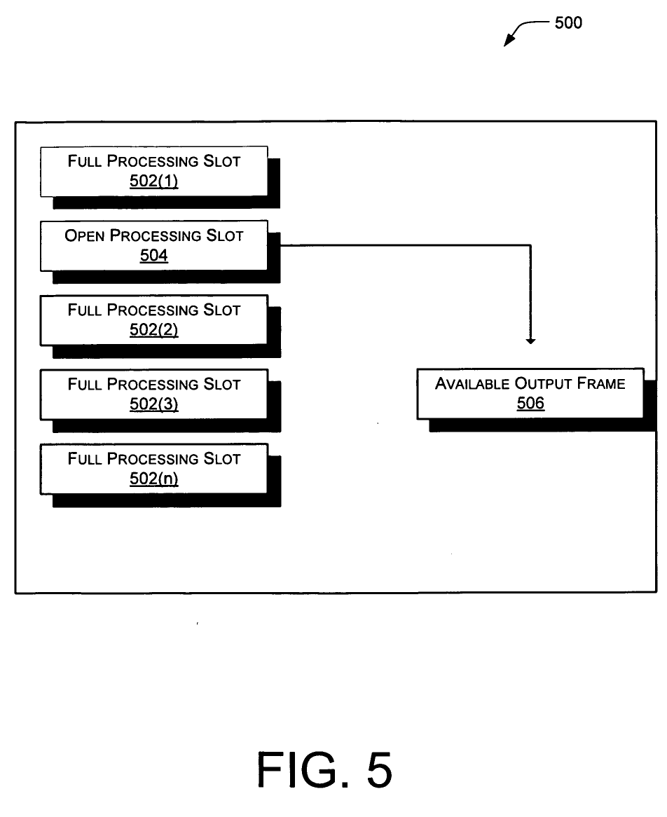

FIG. 5 illustrates a block diagram of an exemplary asynchronous media foundation transform. FIG. 5 illustrates AsyncMFT as a complex decoder 500. The complex decoder may operate on several threads and work most efficiently when processing slots 502(1)-502(n) are full at any given time. Since the amount of time needed to decode a frame can vary from frame to frame, only the decoder itself knows when an open processing slot 504 becomes available after outputting an available frame 506, and would therefore like to be fed another input frame. The existence of an open processing slot 504 indicates that the decoder is not fully utilizing all of available resources. Therefore, in order to maximize efficiency, an AsyncMFT would immediately send an event call requesting additional input for processing, to which the caller would respond by obtaining more input from upstream and making a call which would fill the slot again. In this example, AsyncMFT 502 is shown as a complex decoder, however, in other implementations the AsyncMFT may be, without limitation, an audio codec, a video codec, an audio effect, a video effect, a multiplexer, a demultiplexer, a color-space converter, a sample-rate converter, or a video scaler. Therefore, AsyncMFT 502 has full control over exactly when inputs are requested from upstream and when output is to be sent downstream.

Examples of events that AsyncMFT 112 can send to the caller include, without limitation:
METransformNeedInput: This event is associated with a particular input stream for the AsyncMFT and signals that the AsyncMFT wants an input frame on that stream via a call to IMFTransform::Processinput.
METransformHaveOutput: This event signals that the AsyncMFT has an output frame ready and that the caller can pick up via IMFTransform::ProcessOutput.

In addition, IMFMediaEventGenerator interface 604 exposes methods. Example methods include, without limitation, those described below in Table 2.

TABLE 2

| Method | Description |
|---|---|
| IMFMediaEventGenerator::BeginGetEvent | Begins an asynchronous |
| | request for the next event in the |
| | queue. |
| IMFMediaEventGenerator::EndGetEvent | Completes an asynchronous |
| | request for the next event in the |
| | queue. |
| IMFMediaEventGenerator::GetEvent | Retrieves the next event in the |
| | queue. This method is |
| | synchronous. |
| IMFMediaEventGenerator::QueueEvent | Puts a new event in the object's |
| | queue. |
| IMFMediaEventGenerator::RemoteBeginGetEvent | Remotable version of |
| | BeginGetEvent. (Not used by |
| | applications.) |
| IMFMediaEventGenerator::RemoteEndGetEvent | Remotable version of |
| | EndGetEvent. (Not used by |
| | applications.) |

### Exemplary Method Utilizing an AsyncMFT

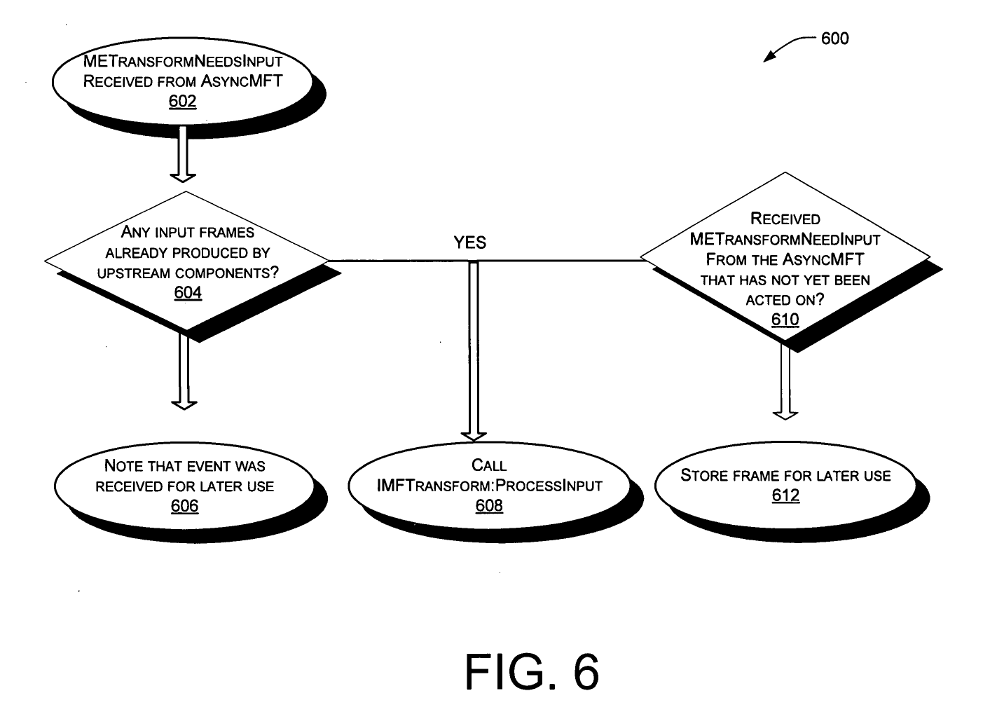

FIG. 6 illustrates a block diagram of an exemplary process flow 600 for obtaining and feeding input frames out of and into the AsyncMFT 112. Note that the process of obtaining input frames for the AsyncMFT is completely independent from the other objects of media foundation pipeline 110. Thus, AsyncMFT 112 may be used as a stand-alone component. The method 600 can be implemented in connection with any suitable hardware, software, firmware or combination thereof. In one embodiment, the method can be implemented using the computer environment and media system similar to those described above in connection with FIGS. 2, 3 and 8 (described below). It is to be appreciated and understood, however, that other computer environments, non-computing environments, and media systems can be utilized without departing from the spirit and scope of the claimed subject matter.

At step 602 a call METransformNeedsInput 602 is received from AsyncMFT 112. Step 604, asks if there are any input frames already produced by upstream components. If there are no input frames available, a note 606 is made that an event was received such that when an input frame becomes available the input frame will be sent to AsyncMFT 112. However, if there is an input frame available, that input frame can be handed to the AsyncMFT via IMFTransform: :ProcessInput at step 608. The media foundation pipeline 110 or other code hosting the AsyncMFT may inquire at step 610 if a request for input from the AsyncMFT 112 has been received from a call 608 but has not yet been acted on. If a frame is produced, but not needed, the frame may be stored at step 612 for later use.

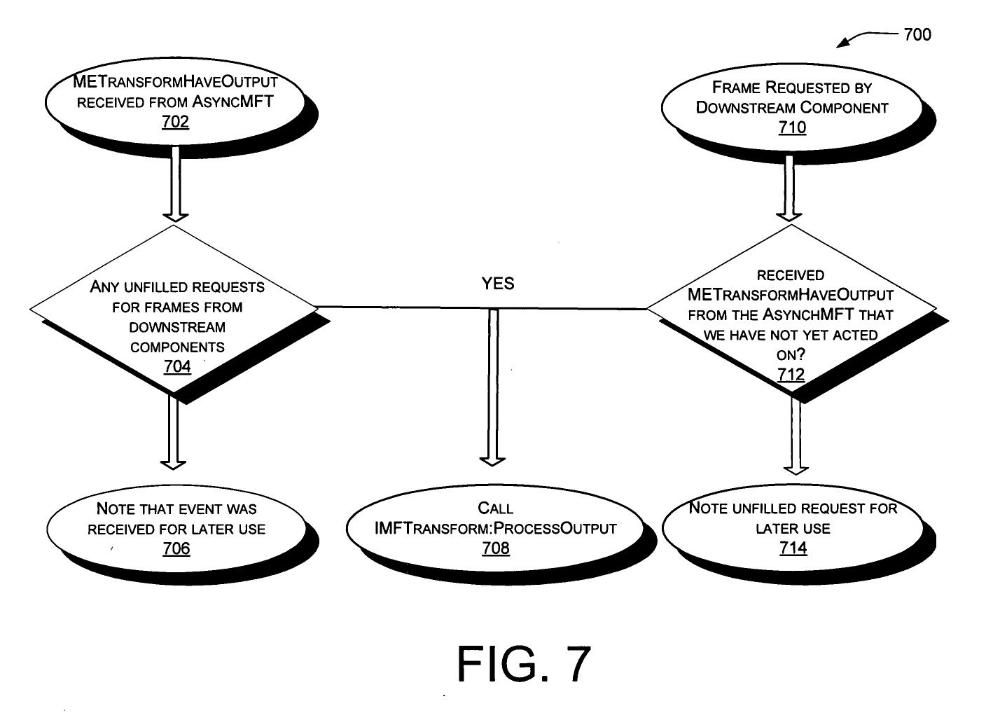

FIG. 7 illustrates a typical process for retrieving output frames from an asynchronous media foundation transform 700 according to FIG. 4. FIG. 7 illustrates the process for retrieving output frames from AsyncMFT 112. Again, note that the process of retrieving output frames from the AsyncMFT is completely independent from the other objects of media foundation pipeline 110 and AsyncMFT 112 may be used as a stand-alone component.

At step 702 a call METransformHaveOutput is received from AsyncMFT 112. At step 704, AsyncMFT 112 inquires as to whether there are any unfilled requests for frames downstream components. If there are no unfilled requests, note 706 is made indicating that an event was received for later use. If there are unfilled requests from downstream components, at step 708 IMFTransform::ProcessOutput is called to retrieve one or more frames, and requested frames 710 are sent downstream. The pipeline or other code hosting the AsyncMFT may inquire at step 712 if they have received output frames that have not yet acted on. If there are no frames to be sent to the downstream components at the time requested, note 714 is made making record of the unfilled request to be fulfilled when a frame becomes available.

### Computing Environment

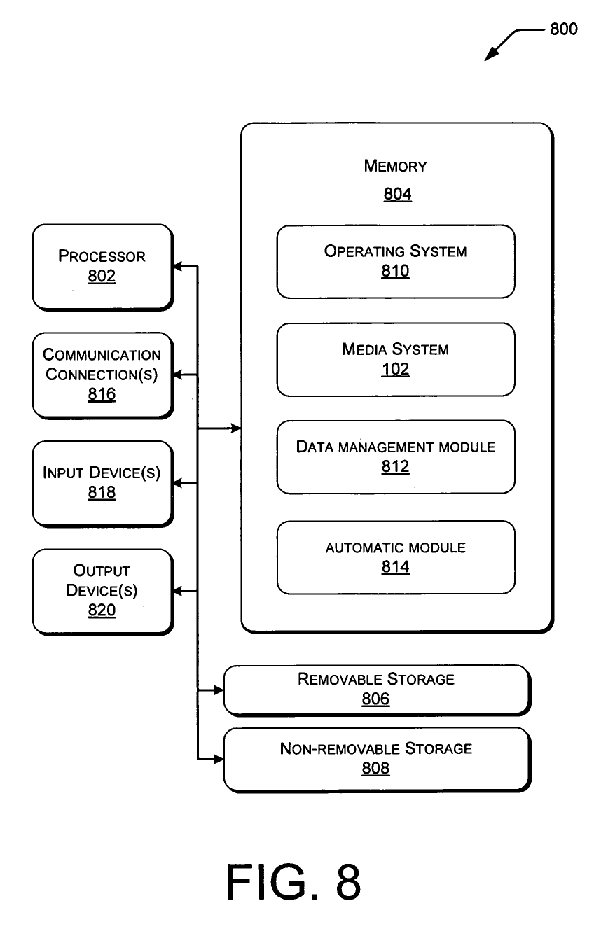

FIG. 8 is a schematic block diagram of an exemplary general operating system 800. The system 800 may be configured as any suitable system capable of implementing the media system 102. In one exemplary configuration, the system comprises at least one processor 802 and memory 804. The processing unit 802 may be implemented as appropriate in hardware, software, firmware, or combinations thereof. Software or firmware implementations of the processing unit 802 may include computer- or machine-executable instructions written in any suitable programming language to perform the various functions described.

Memory 804 may store programs of instructions that are loadable and executable on the processor 802, as well as data generated during the execution of these programs. Depending on the configuration and type of computing device, memory 804 may be volatile (such as RAM) and/or non-volatile (such as ROM, flash memory, etc.). The system may also include additional removable storage 806 and/or non-removable storage 808 including, but not limited to, magnetic storage, optical disks, and/or tape storage. The disk drives and their associated computer-readable medium may provide non-volatile storage of computer readable instructions, data structures, program modules, and other data for the communication devices.

Memory 804, removable storage 806, and non-removable storage 808 are all examples of the computer storage medium. Additional types of computer storage medium that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 104.

Turning to the contents of the memory 804 in more detail, may include an operating system 810 and one or more media systems 102. For example, the system 800 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location.

In one implementation, the memory 804 includes the media system 102, a data management module 812, and an automatic module 814. The data management module 812 stores and manages storage of information, such as images, ROI, equations, and the like, and may communicate with one or more local and/or remote databases or services. The automatic module 814 allows the process to operate without human intervention.

The system 800 may also contain communications connection(s) 816 that allow processor 802 to communicate with servers, the user terminals, and/or other devices on a network. Communications connection(s) 816 is an example of communication medium. Communication medium typically embodies computer readable instructions, data structures, and program modules. By way of example, and not limitation, communication medium includes wired media such as a wired network or direct-wired connection, and wireless media such as acoustic, RF, infrared and other wireless media. The term computer readable medium as used herein includes both storage medium and communication medium.

The system 800 may also include input device(s) 818 such as a keyboard, mouse, pen, voice input device, touch input device, etc., and output device(s) 820, such as a display, speakers, printer, etc. The system 800 may include a database hosted on the processor 802. All these devices are well known in the art and need not be discussed at length here.

### Conclusion

Although embodiments for processing media data on a media system have been described in language specific to structural features and/or methods, it is to be understood that the subject of the appended claims are not necessarily limited to the specific features or methods described. Rather, the specific features and methods are disclosed as exemplary implementations.

What is claimed is:

1. A system for processing media data comprising:
a pipeline of discrete components, the discrete components comprising:
one or more media sources;
one or more asynchronous media foundation transforms (AsyncMFTs), wherein media data received from the one or more media sources is acted upon by the one or more AsyncMFTs;
one or more media sinks receiving the media data from the one or more AsyncMFTs; and
at least one media foundation interface, wherein the media foundation interface comprises:
listening for an event requesting the media data from at least one of the one or more media sources; and
listening for an event requesting that the one or more AsyncMFTs send the media data to the one or more media sinks.

2. The media system of claim 1, further comprising one or more paths within the pipeline, wherein the one or more paths comprises one or more AsyncMFTs.

3. The media system of claim 1, wherein the pipeline controls the operation of the AsyncMFT.

4. The media system of claim 1, wherein the AsyncMFT operates in isolation from remaining discrete components of the pipeline.

5. The media system of claim 1, wherein the media foundation interface comprises an IMFMediaEventGenerator interface and an IMFTransform interface.

6. The media system of claim 1, further comprising an event signaling that an output frame is ready for pickup by the AsyncMFT.

7. The media system of claim 1 wherein the media source comprises at least one of a substantially real-time content or a non real-time content.

8. The media system of claim 1, wherein the AsyncMFT acting upon the media data comprises at least one of an audio codec, a video codec, an audio effect, a video effect, a multiplexer, a demultiplexer, a tee, a color space converter, a sample-rate converter, or a video scaler.

9. The media system of claim 1, wherein the AsyncMFT is software based or hardware based.

10. One or more computer-readable storage media containing instructions that are executable by a computing device to perform actions comprising:
generating media data from a source object, wherein the media data is comprised of one or more media frames;
implementing at least one interface of an AsyncMFT within a media pipeline to coordinate a flow of the one or more media frames, wherein the one or more interfaces makes an input call and an output call; and
receiving the one or more media frames at a pipeline object.

11. One or more computer-readable storage media of claim 10, wherein the pipeline object comprises a media sink which presents the media frames for playback.

12. One or more computer-implemented method of claim 10, further comprising one or more paths within the media foundation pipeline, wherein a first path is for a video rendering and a second path is for an audio rendering.

13. A programming interface for implementing an asynchronous method for processing media data within a media system, the method comprising:
generating a first event requesting input from an upstream object; and
providing an output frame to a downstream object.

14. The programming interface of claim 13, wherein the upstream object comprises a media source or one or more asynchronous media foundation transformers.

15. The programming interface of claim 14, wherein the media source comprises at least one of a substantially real-time content or a non real-time content.

16. The programming interface of claim 13, wherein the downstream object comprises a media sink or a second media foundation transform.

17. The programming interface of claim 16, wherein the media sink comprises a renderer sink.

18. The programming interface of claim 17, further comprising a renderer sink is associated with a particular type of media content.

19. The programming interface of claim 16, wherein the media sink comprises an archive sink.

20. The programming interface of claim 13, generating a second event requesting that the output frame be sent to the downstream component.
